(19) United States
(12) Patent Application Publication
(10) Pub. No.: US 2026/0021769 A1
(43) Pub. Date: Jan. 22, 2026

(54) INDIRECT VISION SYSTEM AND VEHICLE WITH VISION SYSTEM

(71) Applicant: MEKRA Lang GmbH & Co. KG, Ergersheim (DE)

(72) Inventors: Susanne LANG, Ergersheim (DE); Elmar FINKENBERGER, Adelshofen (DE); Florian ENDRES, Burgbernheim (DE); Michael HECKEL, Weidenbach (DE)

(21) Appl. No.: 19/277,051

(22) Filed: Jul. 22, 2025

(30) Foreign Application Priority Data
Jul. 22, 2024 (DE) 10 2024 120 759.0

(51) Int. Cl. B60R 1/28; B60R 1/00

(52) U.S. Cl. CPC B60R 1/28; B60R 1/003; B60R 2300/101

(57) ABSTRACT

An indirect vision system is provided for a vehicle comprising a towing vehicle and an attachment device, the indirect vision system comprising a vision element, a bearing structure, and an adjustment unit. The bearing structure forms a vehicle connection of the vision system and the vision element is connected to the vehicle connection via the bearing structure. The adjustment unit comprises a vision-element adjustment element for adjusting the vision element and/or a bearing-structure adjustment element for adjusting the bearing structure. The vision system is configured to automatically adjust the adjustment unit depending on geometric dimensions and/or a state and/or a global position of the attachment device. In addition, the disclosure relates to a vehicle with the vision system.

### BACKGROUND

The present disclosure relates to an indirect vision system for a vehicle comprising a towing vehicle and an attachment device, in particular for a commercial vehicle, preferably for an agricultural vehicle or a construction machine or for a truck. In addition, the present disclosure relates to a vehicle comprising a towing vehicle and an attachment device, in particular a commercial vehicle, preferably an agricultural vehicle or a construction machine or a truck, with such a vision system.

Indirect vision systems for vehicles via which a driver of the vehicle can view a region of interest are already known from the state of the art. Such vision systems usually have a vision element and a bearing structure for attaching the vision element to the vehicle. In order to be able to view different regions of interest, known vision systems have an adjustment unit. These are used in particular to adjust a position/pose/alignment of the vision element by changing the vision element itself and/or by changing the bearing structure in relation to the vehicle as required.

In particular, when used in a vehicle region in which the vehicle has a towing vehicle and an attachment device, different situations arise for which a sometimes considerable adjustment of the vision element and/or of the bearing structure is required. These situations are caused in particular by the fact that the attachment device, seen as such, has large geometric dimensions that vary greatly depending on its application. In particular, in the case of a multi-part structure of the adjustment unit, in which both the bearing structure and the vision element can be adjusted to make particularly wide or long vehicles visible, the necessary adjustment of the adjustment unit may be complex and time-consuming, which in turn may pose a safety risk during operation of the vehicle.

In general, automatic adjustment units are already known to support the driver in the adjustment of indirect vision systems:

For example, so-named panning (swiveling) in camera systems is known from EP 3 168 083 B1, EP 3 501 897 B1 and EP 3 882 080 A1, in which a rotational movement of vehicle wheels is detected by sensors and, based on this, an image section displayed for a driver is selected so that a specific part of the vehicle is displayed within the image section at all times.

The automatic adjustment of vision systems is also known from the vehicle region in such a way that the vision system is adjusted when reversing, for example by folding down the side mirrors, so that the driver can see a ground and curbstone area, or that the vision system displays a maneuvering view for the driver when reversing.

### SUMMARY

However, automatic adjustment units are not yet known for certain areas of application in which complex adjustment is required, in particular for the application described above, i.e. in the area of vehicles with towing vehicles and attachment devices.

It is thus the object of the present disclosure to avoid or at least reduce the disadvantages of the prior art. In particular, an indirect vision system is to be provided which ensures an optimum view for the driver, if possible, at all times without distracting the driver from controlling the vehicle, thereby providing safe operation of the vehicle and increasing the safety of all road users.

The object underlying the present disclosure is solved by an indirect vision system with the features of patent claim 1 and by a vehicle with the features of the independent patent claim.

Accordingly, the object of the present disclosure is solved by an indirect vision system for a vehicle, in particular for a commercial vehicle, preferably for an agricultural vehicle or a construction machine or for a truck. The vehicle comprises a towing vehicle and an attachment device (pulled by the towing vehicle). The attachment device is understood to be in particular towed, i.e. in particular not independently drivable, and uncouplable/replaceable devices, such as trailers. An attachment device may be, for example, a working tool such as a plough, fertilizer spreader, rotary harrow, sprayer, etc. The attachment device or working tool may also be integrated on/in the towing vehicle or may be connected to the towing vehicle so that it cannot be uncoupled. This means that the vehicle may also be a combination of towing vehicle and attachment device, i.e. a self-propelled working machine. A self-propelled working machine may be, for example, a (beet) harvester, forage harvester, etc.

The vision system has a vision element. In particular, the vision element may be a mirror glass or an optical sensor unit.

The vision system comprises a bearing structure. The bearing structure forms a vehicle connection of the vision system. The vision element is connected to the vehicle connection via the bearing structure. The vision element may be connected directly or indirectly to the bearing structure. For example, the vision element may be attached to one end of the bearing structure and the vehicle connection may be formed at another end of the bearing structure. For example, the vision system may also have at least one vehicle connection and at least one connection of the vision element.

The vision system comprises an adjustment unit. The adjustment unit has a bearing-structure adjustment element for adjusting the bearing structure and/or a vision-element adjustment element for adjusting the vision element. The bearing-structure adjustment element is used in particular for physically adjusting the bearing structure. The vision-clement adjustment element is used in particular for a physical and/or digital adjustment of the vision element. Physical adjusting is understood in particular as the opposite of the digital adjusting. The physical adjusting may preferably be understood as a mechanical, electromechanical and/or electrical movement. Digital adjusting may preferably be understood as changing a reading region on an image sensor and/or (subsequently) moving a displayed partial region (cut out from the reading region). In particular, the vision element may be connected to the bearing structure via the vision-element adjustment element. The adjustment of the adjustment unit is used to position the vision element in relation to the vehicle connection and thus in relation to a region of interest or field of view, in particular the driver's field of vision.

According to the present disclosure, the vision system is configured to automatically adjust the adjustment unit as a function of geometric dimensions and/or a state, and/or a global position of the attachment device, is in particular determined by satellite. The global position may be a GPS position in particular. However, the global position may also be determined or fixed by other satellite-based (localization) systems, such as Galileo, Glonass or Beidou.

The geometric (external) dimensions of the attachment device are understood in particular to be a length and/or a width and/or a number of axes of the attachment device. The geometric dimensions may also be stored via an attachment device type.

The state of the attachment device is understood in particular to mean an operating mode of the attachment device that has a direct effect on the geometric (outer) dimensions of the attachment device. This means that the attachment device has a greater width or length in a first state than in a second state. For example, the attachment device may have a device such as a spreading device or a plowing device that is coupled/extended/folded out/swung out/lowered in the first state and is uncoupled/retracted/folded in/swung in/lifted up in the second state. The state may also be understood to mean information that no attachment device is attached to the towing vehicle. The state of the attachment device is also understood in particular to mean an operating mode of the attachment device which has a direct effect on a position of a region of interest of the attachment device to be viewed. This means that in a first state, a different area of the attachment device should be visible for vehicle control than in a second state of the attachment device. For example, when the vehicle is turning in the field, a different area of the attachment device may be relevant than when the vehicle is in working mode.

The global position or GPS position of the attachment device is understood in particular to mean information about whether the attachment device is located on public roads, paths and squares, i.e. in road traffic, and the vision system must therefore meet special legal requirements with regard to a field of view that is fixed for the vision system, or whether the attachment device is located on private property, i.e. in particular on a field, and the field of view may be adjusted more freely. The global position may be received by the vehicle in particular and may be made available via a communication interface of the vision system.

An automatic adjustment is understood in particular to be an adjustment without active interaction or without manual triggering of the adjustment by a driver. This means that no manual actuation (e.g. by pressing a button) is required to trigger an automatic adjustment (e.g. to a pre-stored position). In other words, manual triggering is not to be equated with a manual adjustment. This means that the adjustment according to the disclosure is triggered by a vehicle signal or control signal relating to the attachment device.

In other words, the vision system is configured to automatically trigger and carry out the adjustment/setting of the adjustment unit based on the dimensions and/or situation and/or position in relation to the attachment device. The adjustment is made to adapt to the dimensions or to the situation-related changed dimensions and/or the position-related changed region of interest. This has the advantage that the automated vision system adjustment increases safety when using the attachment device and the driver of the vehicle can be considerably relieved. In particular, the driver may be relieved with regard to time so that he does not have to take the time to readjust the vision system in the respective situation. This reduces the safety risk that may arise in particular if the driver does not take enough time to adjust the vision system, but would not carry out the adjustment with the necessary care under time pressure.

According to a preferred embodiment, the vision system may be configured to move the adjustment unit in one step from a current position to a predefined position. In other words, the vision system is configured to adjust the adjustment unit as a onetime event or without intermediate positions or not over a longer period of time. This means that automatic adjustment in particular does not mean continuous tracking of a field of view, as is the case, for example, with so-named trailer panning (known from DE 10 2017 130 566 B4, for example) or trailer tracking. The adjustment as such (depending on the configuration or construction of the adjustment unit) may be continuous or gradual.

According to a preferred embodiment, the vision system may be configured to adjust the adjustment unit (only) during attachment processes, i.e. driving situations concerning the attachment device. This means that automatic adjustment in particular does not mean adjustment for (purely) route guidance-related adjustment, such as when cornering or reversing into a parking space. The adjustment relating to the attachment device may also be understood to mean a change in the driving situation, such as a change from (legally regulated) road traffic to private property without public traffic, in particular to field operation, which is accompanied by a change in the attachment device and therefore a field of view for the driver has to be adjusted in order to provide the driver with the desired view. Alternatively, a different field of view may also be useful for the driver in field operation, for example, without changing the attachment device.

According to a preferred embodiment, the vision system may have a memory unit for storing predefined positions (or adjustment positions) of the adjustment unit. This means that (different) predefined positions are deposited/stored in the memory unit. In particular, a predefined position is understood to be a target position of the adjustment unit, i.e. of the bearing-structure adjustment element and/or the vision-element adjustment element. This has the advantage that the memory unit may be used to access a specific/desired position from the predefined positions of the adjustment unit, so that inappropriate positions of the adjustment unit (in particular for the attachment device in question) may be avoided more easily.

Preferably, the memory unit may be physically/locally integrated directly into the vision system and/or may be formed by physically/locally externally arranged memory, such as a vehicle memory or a memory cloud, whose memory locations may be accessed by the vision system. This means that the memory unit may be vehicle-bound and/or cross-vehicle or vehicle-independent, may be in particular cloud-based. Cross-vehicle is understood to mean that for one vehicle type, i.e. for one type of towing vehicle and/or attachment device, the data or memory locations may also be used for another vehicle, i.e. towing vehicle and/or attachment device, of the same type.

According to a preferred embodiment, the vision system may comprise a communication interface for transmitting and/or receiving vehicle signals, which in particular contain information about the geometric dimensions, and/or the state, and/or the GPS position of the attachment device. The communication interface may be configured as a data interface, in particular as a bus interface, such as a CAN bus interface and/or an ISOBUS interface, and/or as a network interface, such as a LIN interface and/or an Ethernet interface, and/or as a GPS interface. The vehicle signal may be sent by the vehicle, i.e. the towing vehicle and/or the attachment device.

According to a preferred embodiment, the vehicle signals (or some of the vehicle signals) may each be assigned to a predefined position (from the predefined positions) of the adjustment unit. This means that the vehicle signals correspond to one of the stored, predefined positions or that a unique position of the adjustment unit is assigned to the vehicle signals. One or the same predefined position may also be assigned to several vehicle signals, but several predefined positions cannot be assigned to one or the same vehicle signal.

In addition, the communication interface may be configured to assign the received vehicle signals to a memory location of the associated adjustment position and/or to instruct the stored adjustment position when receiving vehicle signals. This means that the communication interface forms a processing unit or implements a certain processing logic. The communication interface is thus configured to execute the adjustment and to process the management of the memory locations, settings made by the driver, etc.

According to a preferred embodiment, the vision system may be configured to move the adjustment unit to the predefined position of the adjustment unit assigned to the vehicle signal as a function of the vehicle signal. In other words, the vehicle signal (automatically) triggers the adjustment unit to assume the corresponding target position or to be moved to the corresponding target position. This means that when the adjustment unit receives the vehicle signal, depending on the actual position of the adjustment unit, it either performs a corresponding position change or remains in the actual position (which already corresponds to the target position). This means that the automatic adjustment only takes place in particular if the current position or actual position of the adjustment unit does not correspond to the predefined position or target position. This is particularly important if the vehicle signals are received continuously with a certain periodicity or not as a one-off event. However, a driver may override an automatic position adjustment. This means that a driver adjustment or readjusted values have priority.

According to a preferred embodiment, the vehicle signal may contain information for driver identification of the vehicle. The driver identification may take place, for example, via a vehicle key used, an adjusted seat position, a selected driver profile, a measured driver weight or via a so-named drive monitoring. According to the preferred embodiment, the predefined positions of the adjustment unit may be stored in the memory unit as a function of the driver identification or a driver profile. This means that the adjustment unit may (automatically) assume different predefined positions depending on which driver is driving the vehicle. This has the advantage that the vision system is optimally adapted to the individual driver thanks to the personalized adjustment.

According to a preferred embodiment, the vehicle signal may contain information on a vehicle type, in particular on geometric dimensions of the vehicle type, and/or on an attachment device type, in particular on geometric dimensions of the attachment device type. According to the preferred embodiment, the predefined positions of the adjustment unit may be stored in the memory unit as a function of the vehicle type and/or of the attachment device type. This means that the adjustment unit may (automatically) assume different predefined positions depending on which vehicle or attachment device is being controlled. This has the advantage that the geometric dimensions of the vehicle or attachment device may be adequately taken into account. In particular, if the memory unit is configured to be vehicle-independent, the memory unit is preferably configured to store the predefined positions of the adjustment unit depending on the vehicle type or attachment device type.

According to a preferred embodiment, the predefined positions may be manually adjustable and/or readjustable or correctable, in particular via a human-machine interface. In particular, the human-machine interface may take the form of a door control panel, a dashboard monitor or touch display and/or buttons on the steering wheel. This means that a new setting or initial setting of a predefined position and/or a correction of an (already adjusted) predefined position may be carried out manually. The human-machine interface may form a unit directly with the communication interface. Alternatively, the input values may be sent via the vehicle's communication network and may be received and/or processed by the communication interface.

According to the preferred embodiment, a manually adjusted position may be stored as a predefined position in the memory unit. This means that the vision system is configured to store a current (previously manually re-adjusted) position of the adjustment unit as an (additional) predefined position in the memory unit. In this way, further useful predefined positions may be stored.

According to the preferred embodiment, a manually readjusted position of a predefined position (from the predefined positions) may be stored in the memory unit as a corrected predefined position. This means that the vision system is configured to store a current (manually previously corrected/readjusted) position of the adjustment unit as the predefined position in the memory unit or to replace the original predefined position. Alternatively, the vision system may be configured to (only) temporarily use a current (manually corrected/adjusted) position of the adjustment unit and then discard it or retain the original predefined position. In this way, the vision system may be particularly individually customized and adapted to the needs of the individual driver.

According to a preferred embodiment, the bearing-structure adjustment element may comprise a mechanical and/or mechatronic component which is configured to perform a linear translational movement and/or a swivel movement. In particular, the bearing-structure adjustment element may serve to increase and/or decrease a distance and/or to adjust an angle of the vision element to the vehicle connection and thus to an interior of the vehicle.

According to a preferred embodiment, the mechanical and/or mechatronic component may be a telescopic rod. In this way, a suitable adjustment of the bearing structure may be made possible in a simple manner.

According to a preferred embodiment, the vision-element adjustment element may have a mechanical and/or mechatronic component which is configured to perform an adjustment movement, in particular a rotary movement or tilting movement, in three spatial directions. According to a preferred embodiment, the mechanical and/or mechatronic component may be a gearbox.

According to a preferred embodiment, the vision-element adjustment element may comprise a digital component which is configured to change a scaling and/or to change a size and/or to change or shift a section of an image region displayed (for the driver). The displayed image region may be part of an entire detection area or reading region or the entire detection arca.

According to a preferred embodiment, the vision system may preferably be configured to display an adjustment made by the digital component as an overlay (or in a superimposed display with the displayed field of view) for the driver. The overlay may be configured specifically for an attachment device. This means that pictograms and/or distance lines and/or a pose of an attachment device end and/or a maneuvering aid, such as a vehicle outline, may be displayed in the overlay. In particular in the case of a digital adjustment, the driver is thus assisted in reorienting himself in the adjusted field of view or adjusting to the adjusted position of the adjustment unit.

According to a preferred embodiment, the vision system may be a mirror system or a camera-monitor system, in particular a mirror replacement system according to UN/ECE R46. The mirror system may have a mirror glass as a vision element. The camera monitor system may comprise an optical sensor unit as vision element and a display unit.

According to a preferred embodiment, the vision system may comprise a heating function for removing ice and/or water on the vision element or a cover covering the vision clement. According to the preferred embodiment, the vision system may be configured to control the heating function depending on the vehicle signals.

Furthermore, the object of the present disclosure is solved by a vehicle comprising a towing vehicle and an attachment device, in particular a commercial vehicle, preferably an agricultural vehicle or construction machine or truck, with the described vision system.

According to a preferred embodiment, the vehicle may have a light source for illuminating an area around the vehicle. According to the preferred embodiment, the vehicle may be set up to control the illuminant depending on the vehicle signals.

In other words, the present disclosure relates to the problem that machines attached to towing vehicles in the agricultural and construction machinery sector lead to a considerable widening of the combination, which is why vision systems for vehicles in the agricultural and construction machinery sector have an adjustment unit, for example in the form of a telescopic rod, which goes beyond the vision system adjustment units known from the passenger car sector and may change the position of the entire vision system unit with respect to the vehicle and may position it further outward or inward as required. In addition to adjusting the vision system unit as such, it is also necessary to be able to adjust the view of the driver in order to ensure driver visibility. In addition to attaching different machines, there are various situations in the agricultural and construction machinery sector that require the vision system to be readjusted, such as switching between road and field operation, turning in the field and the associated headland management, using different attachment devices with a towing vehicle or using different towing vehicles with an attachment device.

### BRIEF DESCRIPTION OF THE DRAWINGS

FIGS. 1 to 2 are schematic representations of an indirect vision system mounted on different vehicles according to a first embodiment,

FIG. 3 is a schematic representation of the indirect vision system mounted on a vehicle according to a second embodiment,

FIGS. 4 and 5 are enlarged schematic representations of the vision system from FIGS. 1 and 2 and FIG. 3 respectively,

FIGS. 6a to 6c are schematic representations of the function of a vision-element adjustment element of the vision system,

FIGS. 7a to 7b are schematic representations of the operation of a bearing-structure adjustment element of the Vision system,

FIGS. 8a to 8b show a constructive configuration of the vision system,

FIG. 9 is a schematic representation of a functional structure of the indirect vision system.

### DETAILED DESCRIPTION

Configuration examples of the present disclosure are described below on the basis of the associated Figures.

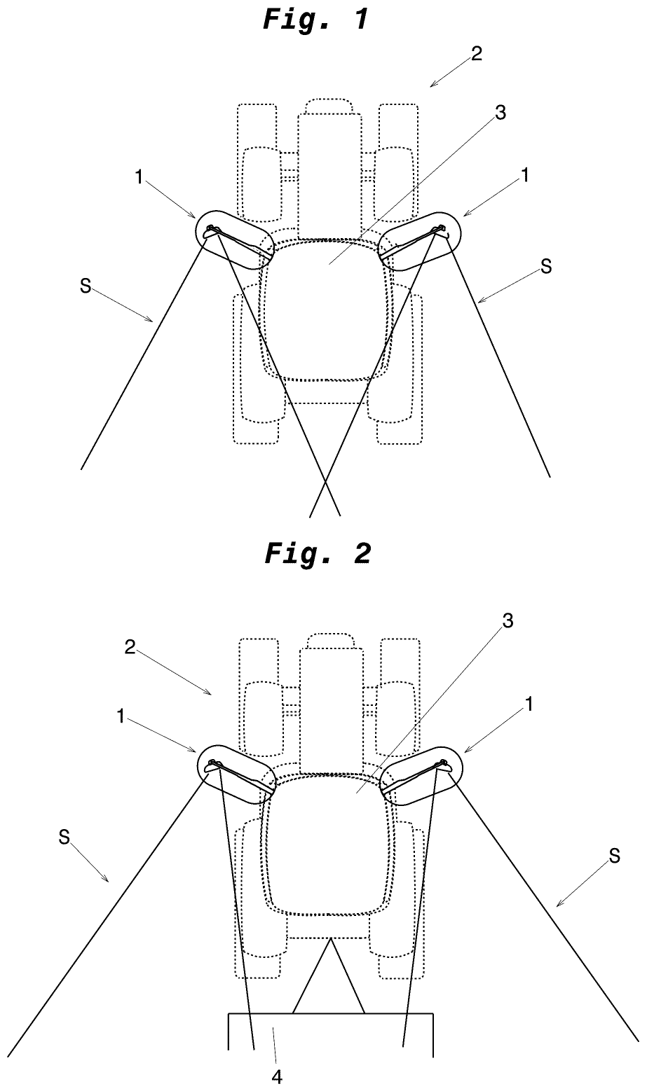

FIG. 1 shows an indirect vision system 1 mounted on a vehicle 2. The vision system 1 may be arranged completely outside the vehicle 2 or partially outside and partially inside the vehicle 2. Parts of the vision system 1 arranged inside the vehicle 2 may be, for example, a display unit (not shown in FIG. 1), a communication interface, a human-machine interface or a memory unit.

The vehicle 2 shown in FIG. 1 (here in the form of a construction machine or agricultural machine) has (only) one towing vehicle 3 or no attachment device 4. The vision system 1 is adjusted so that a region of interest (such as here a lateral, rear vehicle part or towing vehicle part and, in particular, a surrounding area next to the lateral, rear vehicle part or towing vehicle part) is located in a field of view S of the vision system 1.

FIG. 2 shows the indirect vision system 1 mounted on the vehicle 2. The vehicle 2 (here in the form of a construction machine or agricultural machine) has the towing vehicle 3 and an attachment device 4 (pulled by the towing vehicle 3). The vision system 1 is adjusted so that a region of interest (such as here a lateral, rear vehicle part or attachment device part and above all a surrounding area next to the lateral, rear vehicle part or attachment device part) lies in the field of view S of the vision system 1. It can be seen here that the vision system 1 is adjusted in relation to FIG. 1 so that a driver can look past the attachment device 4 at the side and not (only) the attachment device 4—due to its geometric dimensions—itself occupies a large part of the field of view S (which would be the case with an adjustment from FIG. 1).

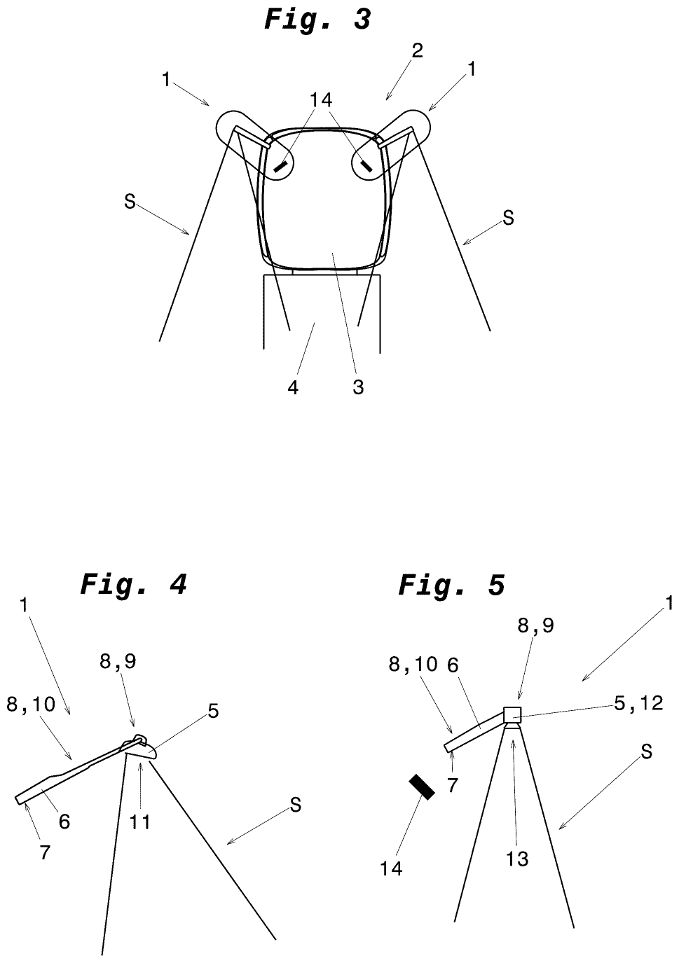

FIG. 3 shows the indirect vision system 1 mounted on the vehicle 2. The vehicle 2 (here in the form of a semitrailer) has the towing vehicle 3 and the attachment device 4 (here in the form of a trailer and pulled by the towing vehicle 3). The vision system 1 is adjusted so that a region of interest (such as here a lateral, rear vehicle part or trailer part and above all a surrounding area next to the lateral, rear vehicle part or attachment device part) lies in the field of view S of the vision system 1. It can be seen here that the vision system 1 (compared to an adjustment (not shown) of the vision system 1 without attachment device 4) is adjusted in such a way that the driver can look past the attachment device 4 at the side and not (only) the attachment device 4—due to its geometric dimensions—itself occupies a large part of the field of view S.

This means that the vehicle 2 is configured in particular as a commercial vehicle, preferably as an agricultural vehicle or a construction machine or a truck. The attachment device 4 means in particular towed, i.e. in particular not independently drivable, and interchangeable devices, such as for example also trailers. However, the vehicle 2, which has the towing vehicle 3 and the attachment device 4, may also be understood to be a combination of towing vehicle 3 and attachment device 4, such as a self-propelled working machine. An attachment device 4 may, for example, be a working tool such as a plough, fertilizer spreader, rotary harrow, sprayer, etc. A self-propelled working machine may be, for example, a (beet) harvester, forage harvester, etc.

FIGS. 4 and 5 each show an enlarged view of the vision system 1. The vision system 1 has a vision element 5 and a bearing structure 6. The vision element 5 is connected to the vehicle 2 via the bearing structure 6. This means that the bearing structure 6 forms a vehicle connection 7.

The vision system 1 has an adjustment unit 8. The adjustment unit 8 has a vision-element adjustment element 9 for adjusting the vision element 5 and/or a bearing-structure adjustment element 10 for adjusting the bearing structure 6. The field of view S of the vision system I can be changed by adjusting the adjustment unit 8.

The vision system 1 may be configured as a mirror system, wherein the mirror system has a mirror glass 11 as the vision element 5 (see FIG. 4). The mirror glass 11 is in the driver's field of vision or can be (directly) seen by the driver. In a mirror system, the field of view S of the vision system 1 is displayed to the driver as a reflection of the field of view or a reflected field of view on the mirror glass 11. The reflected field of view differs depending on the driver or the driver's eye position/perspective.

The vision system 1 may be configured as a digital vision system, such as a camera monitor system, in particular a mirror replacement system according to UN/ECE R46, wherein the camera monitor system has an optical sensor unit 12 with an image sensor 13 as vision element 5 (see FIG. 5). In addition, the digital vision system has a display unit 14, in particular a monitor for displaying a capture area or a partial region of the capture area captured by the optical sensor unit 12 or the image sensor 13. The display unit 14 (and not the optical sensor unit 12) is in the field of vision of the driver or can be (directly) viewed by the driver. The display unit 14 is preferably located inside the vehicle 2. In a digital vision system, the field of view S of the vision system 1 is displayed for the driver as an image of the field of view S or the imaged field of view on the display unit 14. Irrespective of the driver or an eye position/perspective of the driver, the displayed field of view is (always) the same.

The vision-element adjustment element 9 is used in particular for a physical adjustment of the vision element 5 (in the case of a configuration as a mirror system) and/or for a digital adjustment of the vision element 5 (in the case of a digital vision system design). The vision-element adjustment element 9 may have a mechanical or mechatronic component for executing an adjustment movement, in particular a rotary movement or tilting movement, in three spatial directions. The vision-element adjustment element 9 may have a digital component, in particular in the form of a processing unit, for changing a scaling and/or a size and/or a section of a field of view/image region displayed/imaged for the driver or on the display unit 14. The processing unit may comprise a processor.

With digital adjusting, either a partial region of the image sensor 13 or a (complete) area of the image sensor 13 can be read out as a reading region. The image sensor data read out contains raw data, which is processed (by a processing unit of the vision system 1) and (then) available as processed image data. After reading, a (specific) section can be cut out of the raw data and/or the processed image data and can be displayed/imaged/represented (by the display unit 14). This means that cropping can take place at any point before, during or after (image) processing. In particular, cropping can take place before (image) processing in order to reduce the amount of data and/or computing power. Depending on which partial region of the image sensor 13 is read out and/or which section is cut out of the raw data and/or the processed image data and possibly scaled or enlarged/reduced, the field of view depicted for the driver changes.

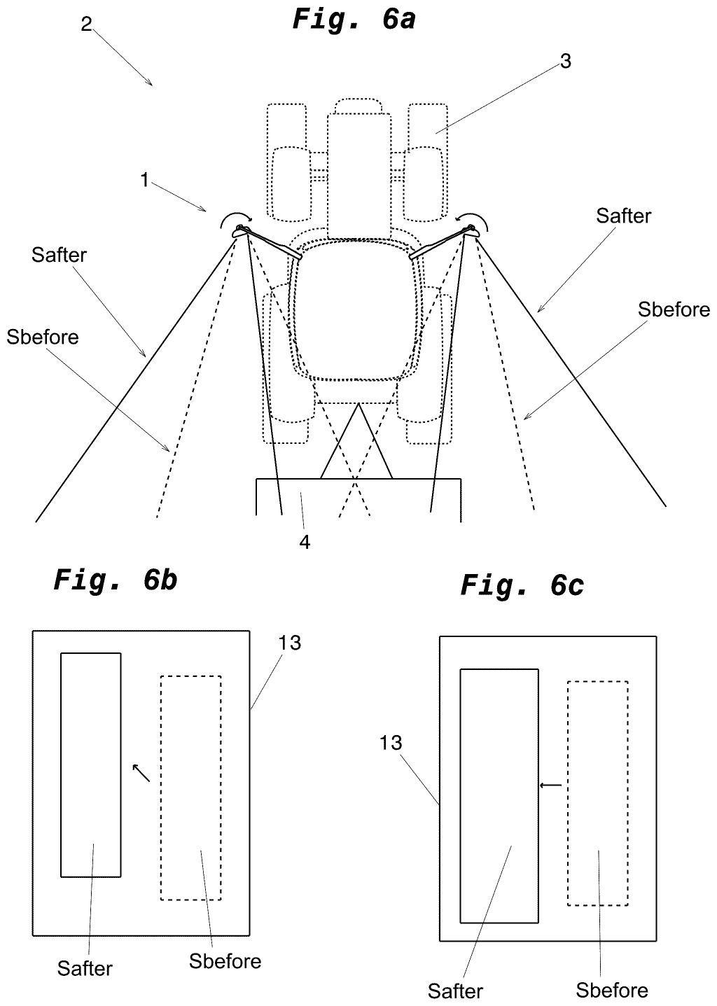

FIG. 6a shows that in order to adjust the vision element 5, the vision element 5 is pivoted, which changes the field of view Sbefore adjusted before the adjustment to a field of view Safter adjusted after the adjustment. Accordingly, the perspective for the driver (in the case of a mirror system) or the position of the image sensor (in the case of a digital vision system) changes and therefore the field of view available to the driver, i.e. the perceivable/visible, reflected or imaged field of view.

FIG. 6b shows that a different section is cut out to adjust the vision element 5, which changes the field of view Sbefore adjusted before the adjustment to a field of view Safter adjusted after the adjustment. The field of view available to the driver, i.e. the perceivable/visible field of view, changes accordingly.

FIG. 6c shows that a size and/or scaling of the section is also changed in order to adjust the vision element 5, as a result of which the field of view Sbefore adjusted before the adjustment changes to a field of view Safter adjusted after the adjustment. The field of view available to the driver, i.e. the perceivable/visible field of view, changes accordingly.

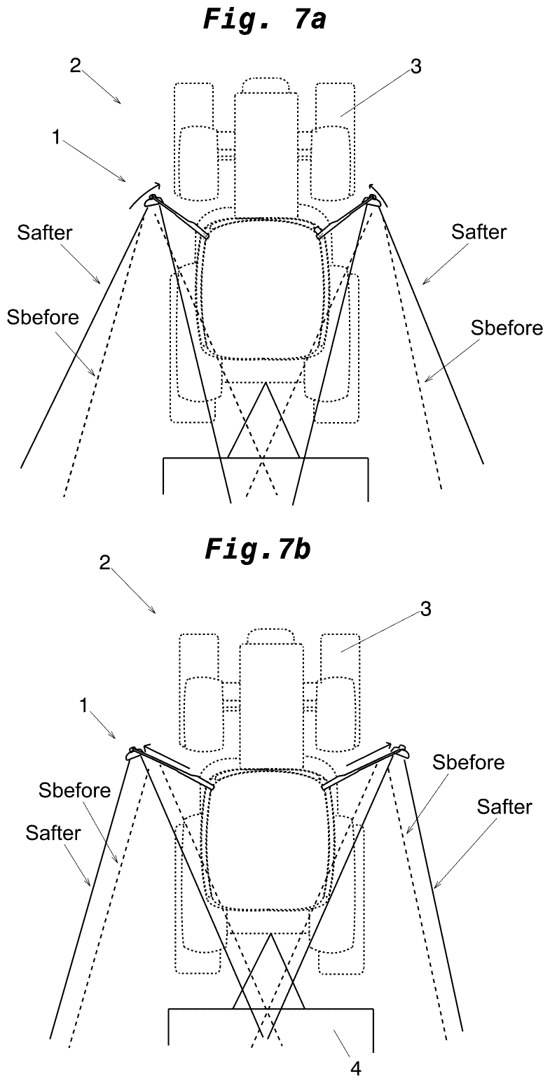

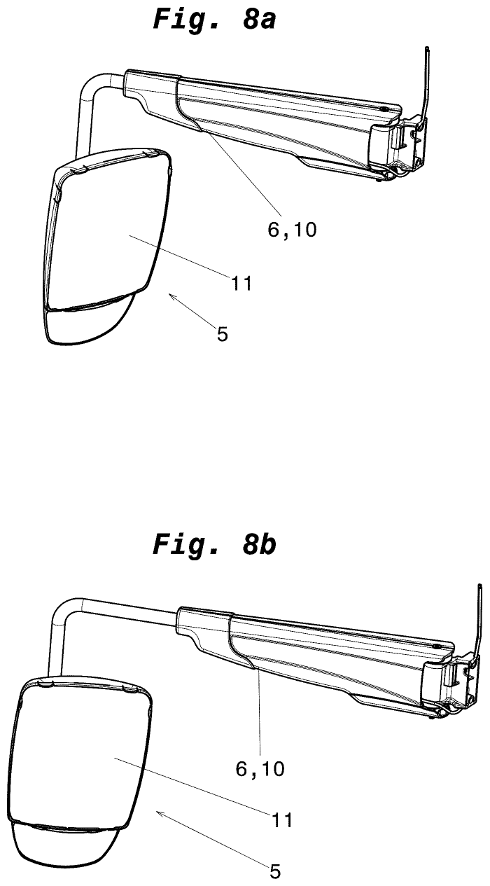

The bearing-structure adjustment element 10 serves in particular to physically adjust the bearing structure 6. The bearing-structure adjustment element 10 may have a mechanical component for executing a linear translation movement (cf. FIG. 7a) and/or a swivel movement (cf. FIG. 7b). In particular, the mechanical component may be a telescopic rod (cf. FIGS. 8a and 8b). By adjusting the bearing-structure adjustment element 10, the field of view Sbefore adjusted before the adjustment changes to a field of view Safter adjusted after the adjustment. Accordingly, the perspective for the driver (in the case of a mirror system) or the position of the image sensor (in the case of a digital vision system) changes and therefore the field of view made available to the driver, i.e. the perceivable/visible, reflected or imaged field of view.

According to the disclosure, the vision system 1 is configured to adjust the adjustment unit 8 as a function of geometric dimensions 15, in particular a length, and/or a width, and/or a number of axes, and/or a state 16, and/or a global position 17, in particular GPS position, of the attachment device 4 automatically, in particular without manual triggering of the adjustment by a driver.

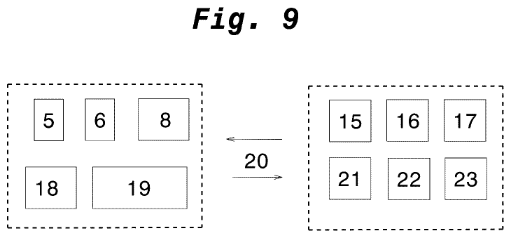

In addition, the vision system 1 may have a memory unit 18 for storing predefined positions of the adjustment unit 8 and a communication interface 19 for transmitting and/or receiving vehicle signals 20, which contain information about the geometric dimensions 15, and/or the state 16, and/or the global position 17, of the attachment device 4 (see FIG. 9). The vehicle signals 20 are each assigned to a predefined position of the adjustment unit 8, and the vision system 1 is configured to adjust the adjustment unit 8 to the predefined position of the adjustment unit 8 assigned to the vehicle signal 20 as a function of the vehicle signal 20.

The vision system 1 may also have a control unit or processing unit or logic. The control unit may also be integrated in the communication interface 19. The control unit may be installed on the vehicle or vision system side.

In addition, the vehicle signal 20 may contain information on a driver identification 21. In particular, the predefined positions of the adjustment unit 8 may be stored in the memory unit 17 depending on the driver identification 21.

In addition, the vehicle signal 20 may contain information on a vehicle type 22 of the vehicle 2. In particular, the predefined positions of the adjustment unit 8 may be stored in the memory unit 18 depending on the vehicle type 22.

In addition, the vehicle signal 20 may contain information on an attachment device type 23 of the vehicle 2. In particular, the predefined positions of the adjustment unit 8 may be stored in the memory unit 18 depending on the attachment device type 23.

Furthermore, the predefined positions may be manually adjustable and/or readjustable, in particular via a human-machine interface. Furthermore, an adjusted position may be stored as a predefined position in the memory unit 18 and/or a manually readjusted position of a predefined position may be stored as a corrected predefined position in the memory unit 18.

### LIST OF REFERENCE CHARACTERS

1 indirect vision system
2 vehicle
3 towing vehicle
4 attachment device
5 vision element
6 bearing structure
7 vehicle connection
8 adjustment unit
9 vision-element adjustment element
10 bearing-structure adjustment element
11 mirror glass
12 optical sensor unit
13 image sensor
14 display unit
15 geometric dimensions of the attachment device
16 state of the attachment device
17 global position of the attachment device
18 memory unit
19 communication interface
20 vehicle signal
21 driver identification
22 vehicle type
23 attachment device type
S field of view
Sbefore field of view adjusted before adjustment
Safter field of view adjusted after adjustment

1-10. (canceled)

11. An indirect vision system for a vehicle that comprises a towing vehicle and an attachment device, the indirect vision system comprising:
a vision element;
a bearing structure, wherein the bearing structure forms a vehicle connection of the vision system and the vision element is connected to the vehicle connection via the bearing structure; and
an adjustment unit, wherein the adjustment unit comprises a vision-element adjustment element for adjusting the vision element and/or a bearing-structure adjustment element for adjusting the bearing structure,
wherein the vision system is configured to automatically adjust, without manual triggering of the adjustment by a driver, the adjustment unit as a function of geometric dimensions, in particular a length and/or a width and/or a number of axes, and/or a state, and/or a global position of the attachment device.

12. The vision system according to claim 11, wherein the vision system is configured to move the adjustment unit in one step from a current position to a predefined position and/or during attachment operations.

13. The vision system according to claim 11, wherein the vision system comprises a memory unit for storing predefined positions of the adjustment unit and a communication interface for transmitting and/or receiving vehicle signals, the vehicle signals containing information about the geometric dimensions, and/or the state, and/or the global position of the attachment device,
wherein the vehicle signals are each assigned to a predefined position of the adjustment unit and the vision system is configured to adjust the adjustment unit to the predefined position of the adjustment unit assigned to the vehicle signal as a function of the vehicle signal.

14. The vision system according to claim 13, wherein the vehicle signal contains information on a driver identification of the vehicle, and/or on a vehicle type, and/or on an attachment device type, and/or the predefined positions of the adjustment unit are stored in the memory unit as a function of the driver identification, and/or of the vehicle type, and/or of the attachment device type.

15. The vision system according to claim 13, wherein the predefined positions are manually adjustable and/or readjustable via a human-machine interface.

16. The vision system according to claim 15, wherein the vision system is configured to store an adjusted position as a predefined position in the memory unit, and/or the vision system is configured to store a manually readjusted position of a predefined position as a corrected predefined position in the memory unit.

17. The vision system according to claim 11, wherein the bearing-structure adjustment element comprises a mechanical and/or mechatronic component for performing a linear translational movement and/or a swivel movement.

18. The vision system according to claim 17, wherein the mechanical and/or mechatronic component is a telescopic rod, and/or the vision-element adjustment element comprises a mechanical and/or mechatronic component for performing an adjustment movement in three spatial directions.

19. The vision system according to claim 11, wherein the vision-element adjustment element comprises a digital component for changing a scaling and/or a size and/or a section of an image region displayed for the driver.

20. The vision system according to claim 19, wherein the vision system is configured to display an adjustment made by the digital component as an overlay for the driver.

21. The vision system according to claim 11, wherein the vision system is a mirror system or a camera monitor system, wherein the camera monitor system comprises an optical sensor unit as vision element and a display unit.

22. The vision system according to claim 21, wherein the vision system is a mirror replacement system according to UN/ECE R46.

23. A vehicle comprising a towing vehicle and an attachment device, wherein the vehicle is a commercial vehicle, an agricultural vehicle, or a construction machine or a truck, the vehicle comprising the vision system according to claim 11.

24. The vision system according to claim 11, wherein the indirect vision system is configured for a commercial vehicle and/or an agricultural vehicle and/or a construction machine and/or a truck.

25. The vision system according to claim 11, wherein the global position is determined by satellite.

26. The vision system according to claim 11, wherein the vision system is configured to automatically adjust the adjustment unit as a function of geometric dimensions, in particular a length and/or a width of the attachment device.

27. The vision system according to claim 11, wherein the vision system is configured to automatically adjust the adjustment unit as a function of a number of axes of the attachment device.

28. The vision system according to claim 11, wherein the vision system is configured to automatically adjust the adjustment unit as a function of a state of the attachment device.

29. The vision system according to claim 11, wherein the vision system is configured to automatically adjust the adjustment unit as a function of a global position of the attachment device.
